(19) United States
(12) Patent Application Publication
(10) Pub. No.: US 2013/0342513 A1
(43) Pub. Date: Dec. 26, 2013

(54) DISPLAY APPARATUS AND METHOD OF DRIVING THE DISPLAY APPARATUS

(71) Applicant: SAMSUNG DISPLAY CO., LTD., Yongin-City (KR)

(72) Inventors: Seonki KIM, Anyang-si (KR); SeHuhn HUR, Yongin-si (KR)

(73) Assignee: SAMSUNG DISPLAY CO., LTD., Yongin-City (KR)

(21) Appl. No.: 13/715,766

(22) Filed: Dec. 14, 2012

(30) Foreign Application Priority Data
Jun. 22, 2012 (KR) 10-2012-0067446

(51) Int. Cl. G09G 5/00

(52) U.S. Cl. CPC G09G 5/00
USPC 345/204

(57) ABSTRACT

A display apparatus includes a controller configured to receive image data associated with at least a first frame and a second frame immediately following the first frame. The controller is further configured to generate image signals using the image data. The display apparatus further includes a data driver configured to generate one or more data signals using the image signals. The display apparatus further includes a display panel configured to display one or more images using the one or more data signals. The image signals include two consecutive first-eye image signals and two consecutive second-eye image signals immediately following or immediately preceding the two consecutive first-eye image signals.

### CROSS-REFERENCE TO RELATED APPLICATION

This application claims priority to Korean Patent Application No. 10-2012-0067446, filed on Jun. 22, 2012, and all the benefits accruing therefrom under 35 U.S.C. §119, the content of the prior application being incorporated herein by reference.

### BACKGROUND OF THE INVENTION

1. Field of the Invention

The present invention relates to a display apparatus and a method of driving the display apparatus. More particularly, the present invention relates to a display apparatus capable of displaying a three-dimensional (3D) image as perceived by a viewer and a method of driving the display apparatus.

2. Description of the Related Art

Traditionally, a display apparatus typically displays a two-dimensional image. Recently, 3D image display apparatuses that display 3D images (as perceived by viewers) have been implemented.

A 3D image display apparatus may provide a 3D image using binocular disparity between human eyes. Since the human eyes are spaced apart and separated from each other by the nose, the same object seen by a viewer may be represented by two images observed at different angles by the two eyes of the viewer, and the two images are transmitted to the viewer's brain. The viewer's brain mixes the images with each other such that the viewer perceives a 3D image of the object.

3D image display apparatuses may be classified into two types: stereoscopic 3D displays and auto-stereoscopic 3D displays, according to whether the viewer wears special glasses.

For auto-stereoscopic 3D displays, lenticular methods and parallax barrier methods have been implemented. For stereoscopic 3D displays, polarization methods and shutter glass methods have been developed.

In a 3D image display apparatus implemented using a shutter glass method, a left-eye shutter and a right-eye shutter of shutter glasses may be alternately opened in synchronization with a display period of a left-eye image and a right-eye image. If a liquid crystal display is used in the 3D image display apparatus, a left-eye image displayed during a left-eye frame may exert substantial influence on a right-eye image displayed during a right-eye frame, and a right-eye image displayed during a right-eye frame may exert substantial influence on a left-eye image displayed during a left-eye frame, due to insufficient response speed of liquid crystals. As a result, the image display quality may be unsatisfactory.

In order to mitigate the undesirable cross-influence, a black image may be inserted between the left-eye image and the right-eye image. Nevertheless, brightness of the presented 3D image may be undesirably lowered.

### SUMMARY OF THE INVENTION

Embodiments of the present invention may be related to a display apparatus capable of providing satisfactory brightness when displaying 3D images.

Embodiments of the present invention may be related a method for displaying 3D images with satisfactory brightness.

One or more embodiments of the invention may be related to a display apparatus that includes a controller configured to receive image data that is associated with at least a first frame and a second frame immediately following the first frame. The controller may be further configured to generate image signals using the image data. The display apparatus may further include a data driver configured to generate one or more data signals using the image signals. The display apparatus may further include a display panel configured to display one or more images using the one or more data signals. The image signals may include two consecutive first-eye image signals and two consecutive second-eye image signals immediately following or immediately preceding the two consecutive first-eye image signals.

In one or more embodiments, the two consecutive first-eye image signals may be two left-eye image signals, and the two consecutive second-eye image signals may be two right-eye image signals.

In one or more embodiments, the two consecutive first-eye image signals may be two right-eye image signals, and the two consecutive second-eye image signals may be two left-eye image signals.

In one or more embodiments, the image signals may include a first first-eye image signal, a first second-eye image signal immediately following the first first-eye image signal, a second second-eye image signal immediately following the first second-eye image signal, and a second first-eye image signal immediately following the second second-eye image signal. The first first-eye image signal and the first second-eye image signal may be associated with the first frame. The second second-eye image signal and the second first-eye image signal may be associated with the second frame. The two consecutive second-eye image signals may be the first second-eye image signal and the second second-eye image signal. The two consecutive first-eye image signals may include the second first-eye image signal.

In one or more embodiments, the display apparatus may further include a scaler configured to generate the image data using processed data. The image data may include the first first-eye image signal, the first second-eye image signal immediately following the first first-eye image signal, the second first-eye image signal immediately following the first second-eye image signal, and the second second-eye image signal immediately following the second first-eye image signal.

In one or more embodiments, the display apparatus may further include a scaler configured to generate the image data using processed data. The image data may include the first first-eye image signal, the first second-eye image signal immediately following the first first-eye image signal, the second second-eye image signal immediately following the first second-eye image signal, and the second first-eye image signal immediately following the second second-eye image signal.

In one or more embodiments, the display apparatus may further include a scaler configured to generate the image data using processed data. The image data may include the first second-eye image signal, the first first-eye image signal immediately following the first second-eye image signal, the second second-eye image signal immediately following the first first-eye image signal, and the second first-eye image signal immediately following the second second-eye image signal.

In one or more embodiments, the image data may include a first first-eye image signal, a first second-eye image signal, a second first-eye image signal, a second first-eye image signal, a third first-eye image signal, a third second-eye image signal. The image signals may include the first first-eye image signal, the second first-eye image signal immediately following the first first-eye image signal, the second second-eye image signal immediately following the second first-eye image signal, and the third second-eye image signal immediately following the second second-eye image signal. The first first-eye image signal and the second first-eye image signal may be associated with the first frame. The second second-eye image signal and the third second-eye image signal may be associated with the second frame. The two consecutive first-eye image signals may be the first first-eye image signal and the second first-eye image signal. The two consecutive second-eye image signals may be the second second-eye image signal and the third second-eye image signal.

In one or more embodiments, the two consecutive first-eye image signals may include a preceding signal corresponding to a first output frame and a succeeding signal corresponding to a second output frame. The display apparatus may further include a first-eye shutter configured to open when the display panel displays a first image corresponding to the preceding signal and when the display panel displays a second image corresponding to the succeeding signal. The display apparatus may further include a backlight unit configured to change from a light-off state to a light-on state after the first-eye shutter has changed from a shutter-closed state to a shutter-open state for a predetermined period.

In one or more embodiments, the backlight unit may be configured to change from the light-off state to the light-on state during the first output frame.

In one or more embodiments, the backlight unit may be turned off during the second output frame.

In one or more embodiments, the backlight unit may be configured to be off at a transition from the first output frame to the second output frame (and/or at a transition from the first image to the second image).

One or more embodiments of the invention may be related to a method for displaying one or more images. The method may include receiving image data that is associated with at least a first frame and a second frame immediately following the first frame. The method may further include using the image data and using a controller that includes hardware circuitry, to generate image signals. The method may further include using the image signals and using a display panel to display the one or more images. The image signals include two consecutive first-eye image signals and two consecutive second-eye image signals immediately following or immediately preceding the two consecutive first-eye image signals.

In one or more embodiments, the two consecutive first-eye image signals may be two left-eye image signals, and the two consecutive second-eye image signals may be two right-eye image signals.

In one or more embodiments, the two consecutive first-eye image signals may be two right-eye image signals, and the two consecutive second-eye image signals may be two left-eye image signals.

In one or more embodiments, the image signals may include a first first-eye image signal, a first second-eye image signal immediately following the first first-eye image signal, a second second-eye image signal immediately following the first second-eye image signal, and a second first-eye image signal immediately following the second second-eye image signal. The first first-eye image signal and the first second-eye image signal may be associated with the first frame. The second second-eye image signal and the second first-eye image signal may be associated with the second frame. The two consecutive second-eye image signals may be the first second-eye image signal and the second second-eye image signal. The two consecutive first-eye image signals may include the second first-eye image signal.

In one or more embodiments, the method may further include generating the image data using processed data (and using a scaler having hardware circuitry). The image data may include the first first-eye image signal, the first second-eye image signal immediately following the first first-eye image signal, the second first-eye image signal immediately following the first second-eye image signal, and the second second-eye image signal immediately following the second first-eye image signal.

In one or more embodiments, the method may further include generating the image data using processed data (and using a scaler having hardware circuitry). The image data may include the first first-eye image signal, the first second-eye image signal immediately following the first first-eye image signal, the second second-eye image signal immediately following the first second-eye image signal, and the second first-eye image signal immediately following the second second-eye image signal.

In one or more embodiments, the method may further include generating the image data using processed data (and using a scaler having hardware circuitry). The image data may include the first second-eye image signal, the first first-eye image signal immediately following the first second-eye image signal, the second second-eye image signal immediately following the first first-eye image signal, and the second first-eye image signal immediately following the second second-eye image signal.

In one or embodiments, the image data may include a first first-eye image signal, a first second-eye image signal, a second first-eye image signal, a second first-eye image signal, a third first-eye image signal, a third second-eye image signal. The image signals may include the first first-eye image signal, the second first-eye image signal immediately following the first first-eye image signal, the second second-eye image signal immediately following the second first-eye image signal, and the third second-eye image signal immediately following the second second-eye image signal. The first first-eye image signal and the second first-eye image signal may be associated with the first frame. The second second-eye image signal and the third second-eye image signal may be associated with the second frame. The two consecutive first-eye image signals may be the first first-eye image signal and the second first-eye image signal. The two consecutive second-eye image signals may be the second second-eye image signal and the third second-eye image signal.

In one or more embodiments, the two consecutive first-eye image signals may include a preceding signal corresponding to a first output frame and a succeeding signal corresponding to a second output frame. The method may further include keeping a first-eye shutter open when the display panel displays a first image corresponding to the preceding signal and when the display panel displays a second image corresponding to the succeeding signal. The method may further include changing a backlight unit from a light-off state to a light-on state after the first-eye shutter has been changed from a shutter-closed state to a shutter-open state for a predetermined period.

In one or more embodiments, the backlight unit is configured to change from the light-off state to the light-on state during the first output frame.

In one or more embodiments, the method may further include turning off the backlight unit during the second output frame.

In one or more embodiments, the backlight unit may be off at a transition from the first output frame to the second output frame (and/or at a transition from the first image to the second image).

One or more embodiments of the invention may be related to a display apparatus including a display panel that includes a plurality of pixels, a timing controller that receives a first image signal including a left-eye image signal and a right-eye image signal and outputs a second image signal, and an image display controller that allows the second image signal from the timing controller to be used for displaying one or more images in the display panel. The timing controller sequentially outputs a first left-eye image signal and a right-eye image signal in a first frame (as part of the second image signal) and sequentially outputs a second right-eye image signal and a second left-eye image signal in a second frame (as part of the second image signal).

In one or more embodiments, the first frame and the second frame are successive frames.

In one or more embodiments, the first frame is an odd-numbered frame among a plurality of frames, and the second frame is an even-numbered frame among the frames.

In one or more embodiments, the display apparatus further includes a backlight unit that provides a light to the display panel, and the timing controller further outputs a backlight control signal to control the backlight unit.

In one or more embodiments, the timing controller outputs the backlight control signal to turn on the backlight unit during a first period in which the first right-eye image signal and the second right-eye image signal are used for displaying images in the display panel and during a second period in which the second left-eye image signal and the first left-eye image signal are used for displaying images in the display panel.

In one or more embodiments, the timing controller outputs the backlight control signal to turn off the backlight unit during a predetermined time in each of the first period and the second period.

In one or more embodiments, the timing controller further outputs a left-eye shutter control signal and a right-eye shutter control signal to control a set of shutter glasses including a left-eye shutter and a right-eye shutter.

In one or more embodiments, the timing controller outputs the left-eye shutter control signal and the right-eye shutter control signal to open the right-eye shutter during the first period and the left-eye shutter during the second period.

In one or more embodiments, the timing controller outputs the left-eye shutter control signal and the right-eye shutter control signal to close the right-eye shutter during a predetermined time of the first period and the left-eye shutter during a predetermined time of the second period.

In one or more embodiments, the display apparatus further includes a scaler that converts an image signal from an external source to the first image signal including the left-eye image signal and the right-eye image signal and provides the first image signal to the timing controller.

In one or more embodiments, the first image signal has a frequency two times faster than the image signal.

One or more embodiments of the invention may be related to a display apparatus including a display panel that includes a plurality of pixels, a scaler that separates an image signal (corresponding to a first frame and provided from an external source) into a first left-eye image signal and a right-eye image signal to sequentially output the first left-eye image signal and the first right-eye image signal as a first image signal and separates an image signal of a second frame into a second right-eye image signal and a second left-eye image signal to sequentially output the second right-eye image signal and the second left-eye image signal as the first image signal, a timing controller that converts the first image signal to a second image signal appropriate to the display panel and outputs the second image signal, and an image display controller that allows the second image signal from the timing controller to be displayed in the display panel.

In one or more embodiments, the first frame is an odd-numbered frame among a plurality of frames, and the second frame is an even-numbered frame among the frames.

In one or more embodiments, the display apparatus further includes a backlight unit that provides a light to the display panel, and the timing controller outputs a backlight control signal to turn on the backlight unit during a first period in which a first right-eye image signal and a second right-eye image signal are displayed in the display panel and during a second period in which a second left-eye image signal and a first left-eye image signal are displayed in the display panel.

In one or more embodiments, the timing controller outputs the backlight control signal to turn off the backlight unit during a predetermined time in each of the first period and the second period.

In one or more embodiments, the timing controller further outputs a left-eye shutter control signal and a right-eye shutter control signal to control a set of shutter glasses including a left-eye shutter and a right-eye shutter, thereby opening the right-eye shutter during the first period and the left-eye shutter during the second period.

In one or more embodiments, the timing controller outputs the left-eye shutter control signal and the right-eye shutter control signal to close the right-eye shutter during a predetermined time of the first period and the left-eye shutter during a predetermined time of the second period.

One or more embodiments of the invention may be related to a method of driving a display apparatus, which includes a plurality of pixels. The method may include receiving a first left-eye image signal and a first right-eye image signal, receiving a second left-eye image signal and a second right-eye image signal, sequentially applying the first left-eye image signal and the first right-eye image signal to the pixels, and sequentially applying the second right-eye image signal and the second left-eye image signal to the pixels.

In one or more embodiments, the first left-eye image signal and the first right-eye image signal form a first image signal of a first frame, and the second left-eye image signal and the second right-eye image signal form the first image signal of a second frame.

In one or more embodiments, the first frame is an odd-numbered frame among a plurality of frames, and the second frame is an even-numbered frame among the frames.

In one or more embodiments, the method further includes outputting a backlight control signal to control a backlight unit, and the backlight control signal is output to turn on the backlight unit during a first period in which the first right-eye image signal and the second right-eye image signal are displayed in the display panel and during a second period in which the second left-eye image signal and the first left-eye image signal are used for displaying images in the display panel.

In one or more embodiments, the method further includes outputting a left-eye shutter control signal and a right-eye shutter control signal to control a shutter glasses including a left-eye shutter and a right-eye shutter, wherein the left-eye shutter control signal and the right-eye shutter control signal are output to open the right-eye shutter during the first period and the left-eye shutter during the second period.

According to the above, the left-eye image is output during successive two frames, and then the right-eye image is output during successive two frames. Accordingly, the off time of the backlight unit is shortened (in comparison with the off time associated with a conventional apparatus), and thus the brightness of the image displayed in the display apparatus may be improved.

### BRIEF DESCRIPTION OF THE DRAWINGS

The above and other advantages of the present invention will become readily apparent by reference to the following detailed description when considered in conjunction with the accompanying drawings wherein:

FIG. 1 is a block diagram illustrating a display apparatus according to one or more embodiments of the present invention;

FIG. 2 is a view illustrating an input signal and an output signal of a scaler and a timing controller illustrated in FIG. 1;

FIG. 3 is a timing diagram illustrating a relation between an image displayed in a display panel using a second image signal illustrated in FIG. 2, a backlight control signal, a left-eye shutter control signal, and a right-eye shutter control signal;

FIG. 4 is a timing diagram illustrating an another example of a relation between an image displayed in a display panel using a second image signal illustrated in FIG. 2, a backlight control signal, a left-eye shutter control signal, and a right-eye shutter control signal;

FIG. 5 is a timing diagram illustrating the backlight control signal illustrated in FIG. 4, in which an off time of the backlight control signal is changed;

FIG. 6 is a timing diagram illustrating an another example of a relation between an image displayed in a display panel using a second image signal illustrated in FIG. 2, a backlight control signal, a left-eye shutter control signal, and a right-eye shutter control signal;

FIG. 7 is a block diagram illustrating a backlight unit illustrated in FIG. 1;

FIG. 8 is a timing diagram illustrating that light emitting blocks are sequentially turned on and off;

FIG. 9 is a view illustrating first and second image signals in accordance with an operation of a scaler and a timing controller illustrated in FIG. 1 according to one or more embodiments of the present invention;

FIG. 10 is a flowchart explaining a method of driving the display apparatus illustrated in FIG. 1;

FIG. 11 is a view illustrating first and second image signals in accordance with an operation of a timing controller illustrated in FIG. 1 according to one or more embodiments of the present invention;

FIG. 12 is a timing diagram illustrating a relation between an image displayed in a display panel using a second image signal illustrated in FIG. 11, a backlight control signal, a left-eye shutter control signal, and a right-eye shutter control signal;

FIG. 13 is a view illustrating first and second image signals in accordance with an operation of a timing controller illustrated in FIG. 1 according to one or more embodiments of the present invention;

FIG. 14 is a timing diagram illustrating a relation between an image displayed in a display panel using a second image signal illustrated in FIG. 13, a backlight control signal, a left-eye shutter control signal, and a right-eye shutter control signal;

FIG. 15 is a view illustrating a 3D television system according to one or more embodiments of the present invention;

FIG. 16 is a view explaining a process of displaying a broadcast signal from a broadcasting station through a display panel of the 3D television system illustrated in FIG. 15; and

FIG. 17 is a view explaining a process of displaying a broadcast signal from a blue-ray disc through a display panel of the 3D television system illustrated in FIG. 15.

### DETAILED DESCRIPTION

Hereinafter, the present invention will be explained in detail with reference to the accompanying drawings.

Various embodiments are described herein below, including methods and techniques. It should be kept in mind that the invention might also cover an article of manufacture that includes a non-transitory computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out operations pertaining to embodiments of the invention. Examples of such apparatus include a general purpose computer and/or a dedicated computing device when appropriately programmed and may include a combination of a computer/computing device and dedicated/programmable hardware circuits (such as electrical, mechanical, and/or optical circuits) adapted for the various operations pertaining to embodiments of the invention.

Although the terms first, second, third etc. may be used herein to describe various signals, elements, components, regions, layers and/or sections, these signals, elements, components, regions, layers and/or sections should not be limited by these terms. These terms are only used to distinguish one signal, element, component, region, layer or section from another signal, region, layer or section. Thus, a first signal, element, component, region, layer, or section discussed below may be termed a second signal, element, component, region, layer, or section without departing from the teachings of the present invention. The description of an element as “first” does not imply that second or other elements are needed.

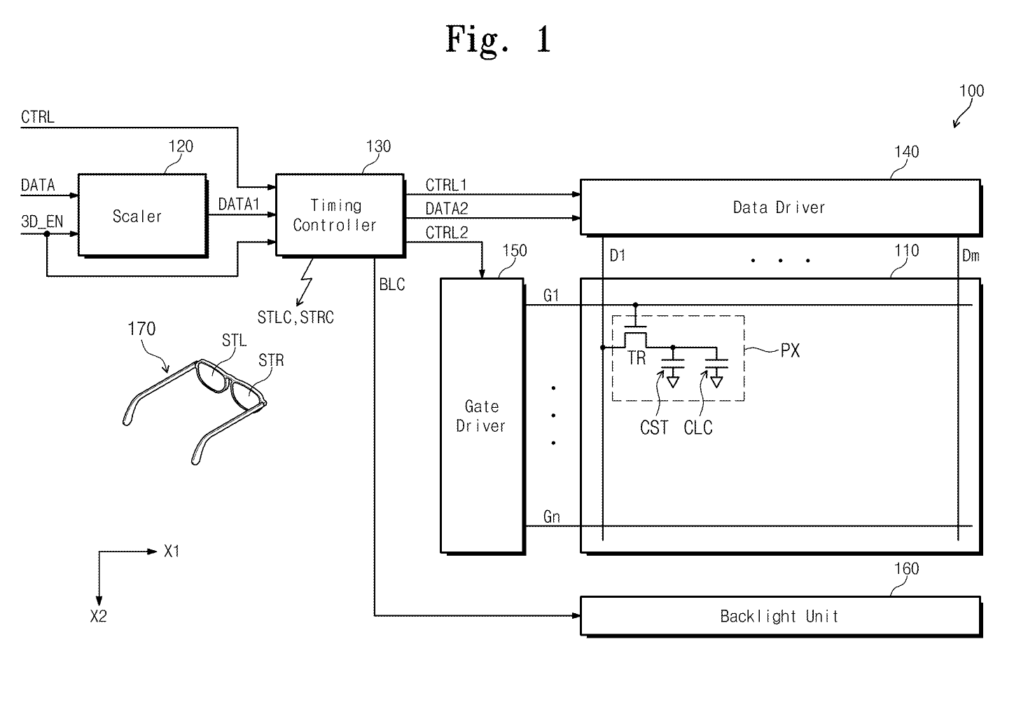

FIG. 1 is a block diagram illustrating a display apparatus according to one or more embodiments of the present invention.

Referring to FIG. 1, a display apparatus 100 includes a display panel 110, a scaler 120, a timing controller 130, a data driver 140, a gate driver 150, and a backlight unit 160. The display apparatus 100 further includes shutter glasses 170. The data driver 140 and the gate driver 150 serve as an image display controller to control the display panel 110 for displaying an image.

The display panel 110 may be, for example, but not limited to, a liquid crystal display panel, an organic light emitting display panel, an electrophoretic display panel, or an electrowetting display panel. In one or more embodiments, the display panel 110 may be a liquid crystal display panel.

The display panel 110 includes a plurality of gate lines G1 to Gn extending in a first direction X1, a plurality of data lines D1 to Dm extending in a second direction X2 and crossing the gate lines G1 to Gn, and a plurality of pixels PX respectively arranged in areas defined by the gate lines G1 to Gn and the data lines D1 to Dm. The data lines D1 to Dm are insulated from the gate lines G1 to Gn. Each of the pixels PX includes a thin film transistor TR, a liquid crystal capacitor CLC, and a storage capacitor CST.

The pixels PX may have the same structure and function, and one of the pixels will be described in detail as an example. The thin film transistor TR includes a gate electrode connected to a gate line G1 of the gate lines G1 to Gn, a source electrode connected to a data line D1 of the data lines D1 to Dm, and a drain electrode connected to a storage capacitor CST connected to the liquid crystal capacitor CLC and the storage capacitor CST. Each of a first end of the liquid crystal capacitor CLC and a first end of the storage capacitor CST is connected to the drain electrode of the thin film transistor TR in parallel. Each of a second end of the liquid crystal capacitor CLC and a second end of the storage capacitor CST is connected to a common voltage.

The scaler 120 converts an image signal DATA from an external source (not illustrated) to a first image signal DATA1 in response to a 3D mode signal 3D_EN. The image signal DATA may be provided from a host, e.g., one or more of a broadcasting station, a computer, etc. Using the image signal DATA, the scaler 120, generates a left-eye image signal and a right-eye image signal when the display apparatus 100 is in a 3D display mode and (sequentially) outputs the left-eye image signal and the right-eye image signal as the first image signal DATA1.

The timing controller 130 receives the first image signal DATA1 from the scaler 120 and control signals CTRL from an external source (not illustrated). The control signals CTRL may include one or more of a vertical synchronization signal, a horizontal synchronization signal, a main clock signal, a data enable signal, etc. The timing controller 130 processes the first image signal DATA1 based on the control signals CTRL to output a second image signal DATA2, applies the second image signal DATA2 and a first control signal CTRL1 to the data driver 140, and applies a second control signal CTRL2 to the gate driver 150. The first control signal CTRL1 may include one or more of a horizontal synchronization start signal, a clock signal, and a line latch signal. The second control signal CTRL2 may include one or more of a vertical synchronization start signal, an output enable signal, a gate pulse signal, and a dummy enable signal. The timing controller 130 may configure the second image signal DATA2 in accordance with an arrangement and a display frequency of the pixels PX of the display panel 110.

In one or more embodiments, the timing controller 130 sequentially outputs a first left-eye image signal and a first right-eye image signal (included in the first image signal DATA1) of a first frame as the second image signal DATA2; the timing controller 130 sequentially outputs a second right-eye image signal and a second left-eye image signal (included in the first image signal DATA1) of a second frame as the second image signal DATA2. The first frame and the second frame are successive frames. For instance, among frames, the first frame may be an odd-numbered frame, and the second frame may be an even-numbered frame; alternatively, the first frame may be an even-numbered frame, and the second frame may be an odd-numbered frame.

The timing controller 130 outputs a backlight control signal BLC to control the backlight unit 160, a left-eye shutter control signal STLC to control a left-eye shutter STL of the shutter glasses 170, and a right-eye shutter control signal STRC to control a right-eye shutter STR of the shutter glasses 170.

The data driver 140 provides data signals to the data lines D1 to Dm in response to the second image signal DATA2 and the first control signal CTRL1 (provided from the timing controller 130).

The gate driver 150 provides gate signals to the gate lines G1 to Gn in response to the second control signal CTRL2 (provided from the timing controller 130). The gate driver 130 may include a gate driver integrated circuit. The gate driver 150 may be implemented using circuits made of one or more of oxide semiconductor material, amorphous semiconductor material, crystalline semiconductor material, polycrystalline semiconductor material, etc.

The backlight unit 160 is disposed under the display panel 110 and/or corresponds to the pixels PX. The backlight unit 160 is turned and/or turned off in response to the backlight control signal BLC provided from the timing controller 130.

The shutter glasses 170 open and close the left-eye shutter STL in response to the left-eye shutter control signal STLC provided from the timing controller 130. The shutter glasses 170 open and close the right-eye shutter STR in response to the right-eye shutter control signal STRC provided from the timing controller 130. The timing controller 130 includes a wireless transmitter to transmit the left-eye shutter control signal STLC and the right-eye shutter control signal STRC, and the shutter glasses 170 includes a wireless receiver to receive the left-eye shutter control signal STLC and the right-eye shutter control signal STRC. The left-eye shutter STL is opened and the right-eye shutter STR is closed when a left-eye image is displayed in the display panel 110. In addition, the left-eye shutter STL is closed and the right-eye shutter STR is opened when a right-eye image is displayed in the display panel 110. As a result, a viewer wearing the shutter glasses 170 perceives the 3D image.

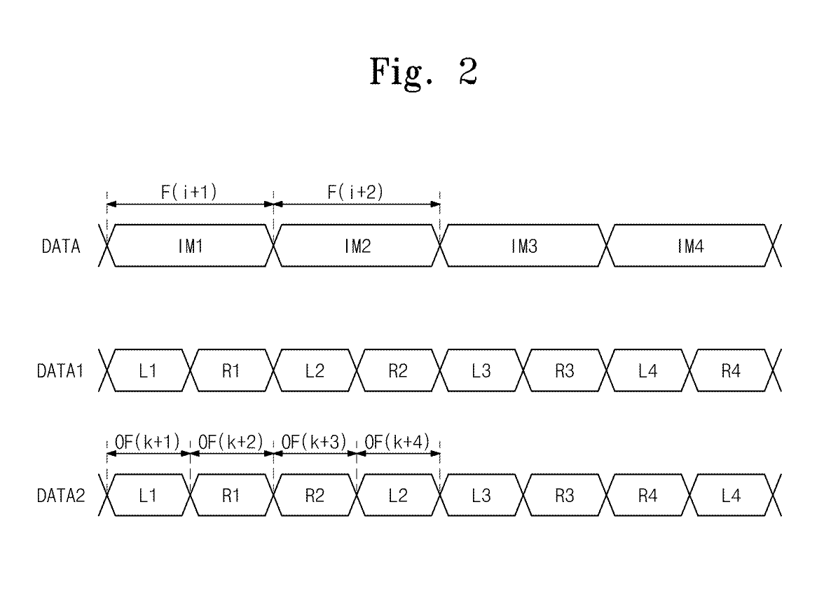

FIG. 2 is a view illustrating an input signal and an output signal of the scaler and the timing controller illustrated in FIG. 1.

Referring to FIGS. 1 and 2, the scaler 120 receives the image signal DATA from the external source (not shown). Using an image signal associated with one frame in the received image signal DATA, the scaler 120 may generate a left-eye image signal and a right-eye image signal. In one or more embodiments, the scaler 120 separates (and/or converts) the image signal associated with one frame in the received image signal DATA into the left-eye image signal and the right-eye image signal. For instance, an image signal IM1 for a first frame F(i+1) is separated (and/or converted) into a first left-eye image signal L1 and a first right-eye image signal R1, and an image signal IM2 for a second frame F(i+2) is separated (and/or converted) into a second left-eye image signal L2 and a second right-eye image signal R2.

The scaler 120 sequentially outputs the left-eye image signal and the right-eye image signal for one frame as the first image signal DATA1 for the one frame. The first image signal DATA1 output from the scaler 120 has a frequency that is two times that of the image signal DATA. For example, when the image signal DATA has a frequency of about 60 Hz, the first image signal DATA1 has a frequency of about 120 Hz.

The timing controller 130 processes the first image signal DATA1 from the scaler 120 in consideration of an operation condition of the display panel 110 and outputs a second image signal DATA2. When the 3D mode signal 3D_EN indicates a 3D display mode, e.g., with a logical high level of the 3D mode signal 3D_EN, the timing controller 130 outputs the second image signal DATA2 by changing an order of the first image signal DATA1 for some of frames.

For example, the first left-eye image signal L1 and the first right-eye image signal R1 for the first frame F(i+1) are sequentially and respectively output during a first output frame OF(k+1) and a second output frame OF(k+2) as the second image signal DATA2 corresponding to the first output frame and the second output frame. The second left-eye image signal L2 and the second right-eye image signal R2 for the second frame F(i+2) are output during a third output frame OF(k+3) and a fourth output frame OF(k+4) in the order of the second right-eye image signal R2 preceding the second left-eye image signal L2 as the second image signal DATA2 corresponding to the third output frame and the fourth output frame.

That is, the left-eye image signals and the right-eye image signals in the first image signal DATA1 for odd-numbered frames, e.g., F(i+1) and F(i+3), are output in the order of the left-eye image signal preceding the right-eye image signal as the second image signal DATA2 for the corresponding output frames. Nevertheless, the left-eye image signals and the right-eye image signals in the first image signal DATA1 for even-numbered frames, e.g., F(i+2) and F(i+4), are output in the order of the right-eye image signal preceding the left-eye image signal as the second image signal DATA2 for the corresponding output frames. The order of a pair of a left-eye image signal and a right-eye image signal for the even-numbered frames, e.g., F(i+2) and F(i+4), is opposite to the order of a pair of a left-eye image signal and a right-eye image signal for the odd-numbered frames, e.g., F(i+1) and F(i+3).

Consequently, in the second image signal DATA2 output from the timing controller 130, right-eye periods each corresponding to two consecutive output frames are alternately arranged with left-eye periods each corresponding to two consecutive output frames, except for the first output frame OF(k+1), in which the first left-eye image signal L1 is output.

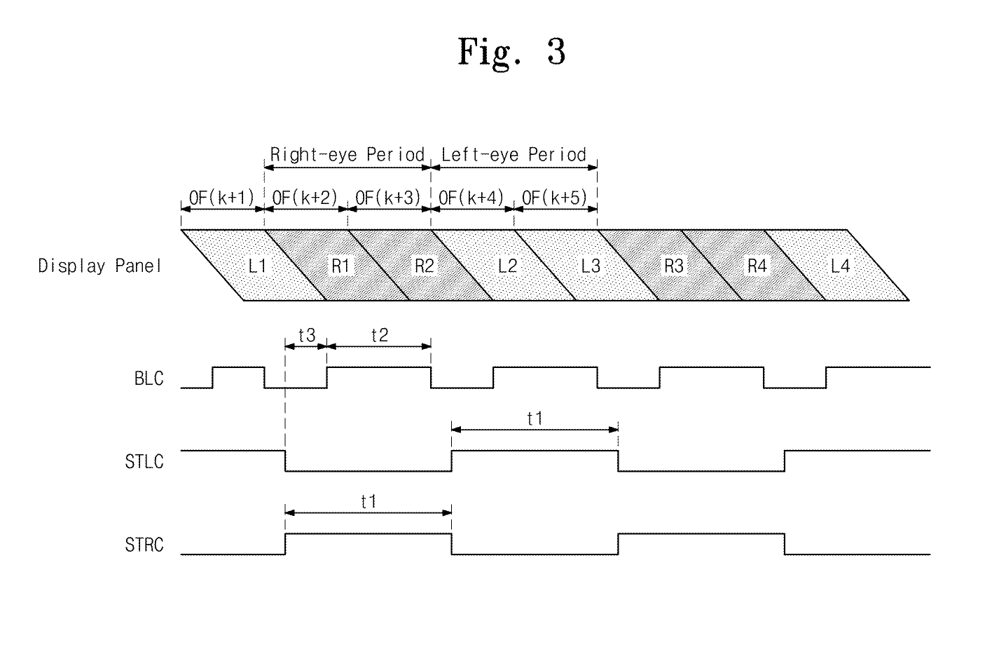

FIG. 3 is a timing diagram illustrating a relation between the image displayed in the display panel using the second image signal illustrated in FIG. 2, the backlight control signal, the left-eye shutter control signal, and the right-eye shutter control signal.

Referring to FIG. 3, in one or more embodiments, the gate lines G1 to Gn illustrated in FIG. 1 are sequentially provided with gate on signals during the first output frame OF(k+1), and thus the first left-eye image signal L1 is displayed in the display panel 110. Similarly, the first right-eye image signal R1, the second right-eye image signal R2, the second left-eye image signal L2, and the third left-eye image signal L3 are displayed in the display panel 110 during the second output frame OF(k+2), the third output frame OF(k+3), the fourth output frame OF(k+4), and the fifth output frame OF(k+5), respectively.

Therefore, right-eye periods, each corresponding to two consecutive output frames, are alternately repeated with left-eye periods, each corresponding to two consecutive output frames, except for the first output frame OF(k+1). The second output frame OF(k+2) and the third output frame OF(k+3), in which the first right-eye image signal R1 and the second right-eye image signal R2 are respectively displayed, correspond to a right-eye period. The fourth output frame OF(k+4) and the fifth output frame OF(k+5), in which the second left-eye image signal L2 and the third left-eye image signal L3 are respectively displayed, correspond to a left-eye period.

The timing controller 130 illustrated in FIG. 1 outputs the left-eye shutter control signal STLC and the right-eye shutter control signal STRC to open the left-eye shutter STL and close the right-eye shutter STR in the left-eye period during which the (two) left-eye image signals are used for displaying (two) corresponding images in the display panel 110. Similarly, the timing controller 130 outputs the left-eye shutter control signal STLC and the right-eye shutter control signal STRC to close the left-eye shutter STL and open the right-eye shutter STR in the right-eye period during which the (two) right-eye image signals are used for displaying (two) corresponding images in the display panel 110.

Accordingly, the left-eye shutter control signal STLC is set to a high level, i.e., a left-shutter-opening level, for (and/or during) the first output frame OF(k+1) and the left-eye periods, including a left-eye period corresponding to the output frames OF(k+4) and OF(k+5), in which left-eye image signals are output such that the display panel 110 displays images corresponding to respective left-eye image signals. The left-eye shutter control signal STLC is set to a low level, i.e., a left-shutter-closing level, for (and/or during) right-eye periods. The right-eye shutter control signal STRC is set to a high level, i.e., a right-shutter-opening level, for (and/or during) the right-eye periods, including a right-eye period corresponding to the output frames OF(k+2) and OF(k+3), in which right-eye image signals are output. The right-eye shutter control signal STRC is set to a low level for (and/or during) left-eye periods (and the first output frame).

The backlight control signal BLC output from the timing controller 130 illustrated in FIG. 1 is set to a high level for (and/or during) an on period t2 shorter than the high level period t1 of each of the left-eye shutter control signal STLC and the right-eye shutter control signal STRC. In one or more embodiments, when a predetermined time t3 lapses after one of the left-eye shutter control signal STLC and the right-eye shutter control signal STRC is transited to the high level from the low level, the backlight control signal BLC is transited to the high level. The configuration is for accommodating the (slow) liquid crystal response speed of the liquid crystal capacitor CLC of the pixel PX.

In addition, the backlight unit 160 is periodically turned on and off in response to the backlight control signal BLC so as to reduce a crosstalk phenomenon caused by, for example, the right-eye image of the right-eye period acting as an afterimage in the left-eye period. Especially, since each of the right-eye period and the left-eye period includes two output frames, the backlight unit 160 is turned on and off every two output frames. Accordingly, the on period t2 in which the backlight unit 160 is turned on is lengthened in comparison with the on period in the driving method of turning on and off the backlight unit 160 every one output frame, and thus brightness in the image displayed in the display panel 110 may be improved with respect to a conventional method.

In one or more embodiments, the gate driver 150 may be implemented using circuits made of one or more of oxide semiconductor material, amorphous semiconductor material, crystalline semiconductor material, polycrystalline semiconductor material, etc. (instead of a gate driver IC) and may be disposed at a side portion of the display panel 110. In one or more embodiments, the frequency of the second data signal DATA2 output from the timing controller 130 is about 120 Hz, and the gate driver 150 may be readily implemented without undue experimentation.

As illustrated in FIG. 3, the frequency of each of the left-eye shutter control signal STLC and the right-eye shutter control signal STRC may be about or exactly one-fourth of the frequency of the second data signal DATA2. In one or more embodiments, the frequency of the second data signal DATA2 output from the timing controller 130 is about 120 Hz, and the frequency of each of the left-eye shutter control signal STLC and the right-eye shutter control signal STRC is about 30 Hz. Accordingly, the open-close frequency of each of the left-eye shutter STL and the right-eye shutter STR is about 30 Hz. Advantageously, power consumption in the shutter glasses 170 may be reduced in comparison with the conventional driving method of turning on and off the shutter glasses 170 every one output frame.

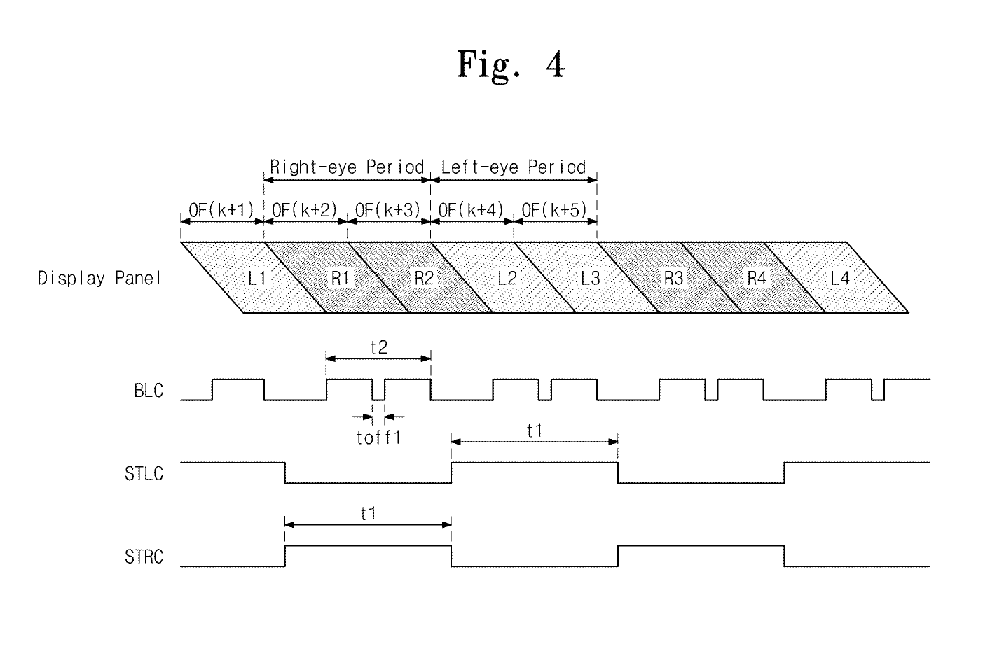

FIG. 4 is a timing diagram illustrating an another example of a relation between the image displayed in the display panel using the second image signal illustrated in FIG. 2, the backlight control signal, the left-eye shutter control signal, and the right-eye shutter control signal.

Referring to FIG. 4, the gate lines G1 to Gn illustrated in FIG. 1 are sequentially provided with gate signals during the first output frame OF(k+1), and thus the first left-eye image signal L1 is displayed in the display panel 110. Similarly, the first right-eye image signal R1, the second right-eye image signal R2, the second left-eye image signal L2, and the third left-eye image signal L3 are displayed in the display panel 110 during the second output frame OF(k+2), the third output frame OF(k+3), the fourth output frame OF(k+4), and the fifth output frame OF(k+5), respectively.

Waveforms of the left-eye shutter control signal STLC, and the right-eye shutter control signal STRC when the images are displayed in the display panel 110 are similar to those illustrated in FIG. 3. Nevertheless, the backlight control signal BLC illustrated in FIG. 4 is different from the backlight control signal BLC illustrated in FIG. 3. As illustrated in FIG. 4, in the on period t2 during which the backlight control signal BLC includes high-level portions, the backlight control signal BLC includes a low-level portion for (and/or during) a predetermined off time toff1.

This configuration is to prevent a flicker phenomenon, which is generated if, for example, the first right-eye image signal R1 in the second output frame OF(k+2) of the right-eye period and the second right-eye image signal R2 in the third output frame OF(k+3) of the right-eye period are reversely driven. The length of the off time toff1, during which the backlight light control signal BLC is temporarily transited to the low level in the on period t2 (which corresponds to high-level portions), may be determined considering brightness and flicker.

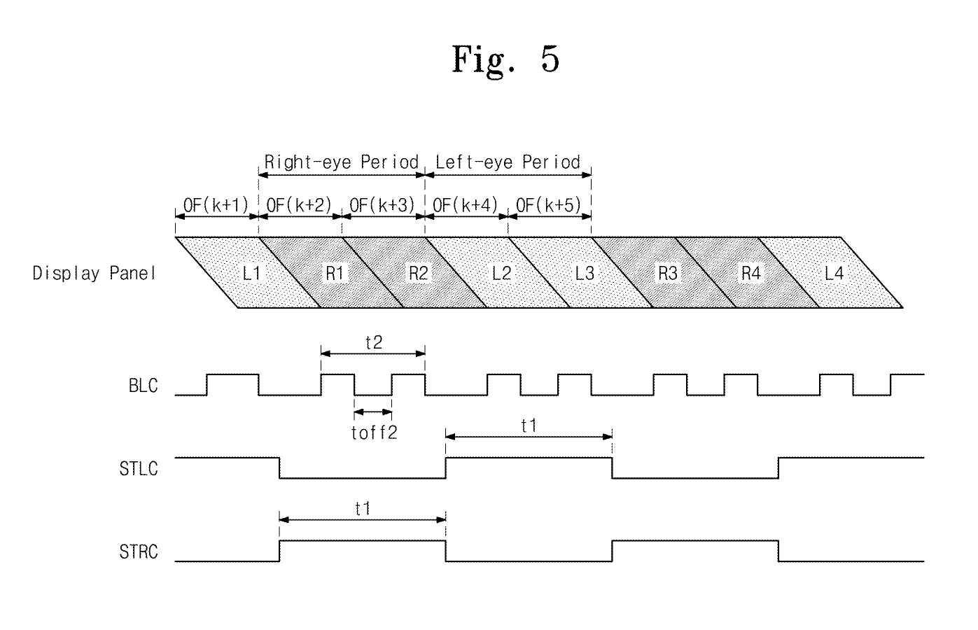

FIG. 5 is a timing diagram illustrating a backlight control signal similar to the backlight control signal illustrated in FIG. 4 and having a different length of the off time of the backlight control signal.

Referring to FIG. 5, the off-period toff2, for (and/or during) which the backlight light control signal BLC is temporarily transited to the low level in the on period t2 (which corresponds to high-level portions), is longer than the off time toff1 illustrated in FIG. 4 (toff1<toff2).

In order to maximize the brightness of the image displayed in the display panel 110, the off time toff1 may be minimized, as illustrated in FIG. 4. On the other hand, the off time toff2 may be relatively lengthened, as illustrated in FIG. 5, to prevent the flicker phenomenon. Thus, a trade-off between the brightness and the flicker may be achieved by controlling the off time toff2 of the backlight control signal BLC output from the timing controller 130.

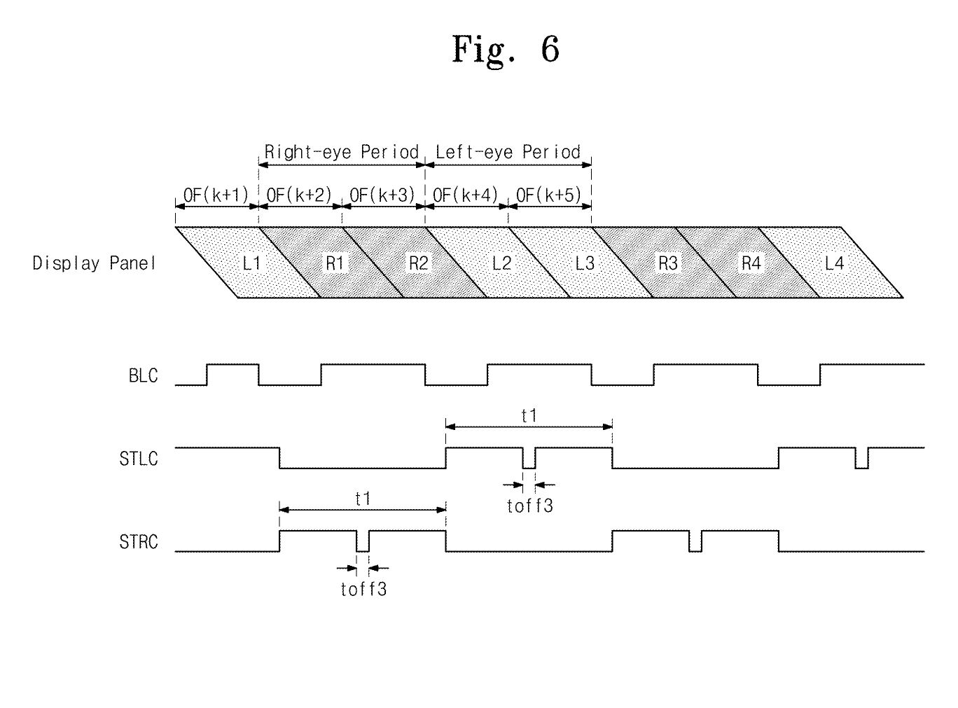

FIG. 6 is a timing diagram illustrating an another example of a relation between the image displayed in the display panel using the second image signal illustrated in FIG. 2, the backlight control signal, the left-eye shutter control signal, and the right-eye shutter control signal.

Referring to FIG. 6, the waveform of the backlight control signal BLC while the image is displayed in the display panel 110 is similar to that of the backlight control signal BLC illustrated in FIG. 3. Nevertheless, the left-eye shutter control signal STLC and the right-eye shutter control signal STRC are transited to the low level for (and/or during) a predetermined off time toff3 in the on period t1 (corresponding to high-level portions) of each of the left-eye shutter control signal STLC and the right-eye control signal STRC.

This configuration is to prevent the flicker phenomenon, which is generated if, for example, the first right-eye image signal R1 in the second output frame OF(k+2) of the right-eye period and the second right-eye image signal R2 in the third output frame OF(k+3) of the right-eye period are reversely driven. The length of the off time toff3, during which the left-eye shutter control signal STLC and the right-eye shutter control signal STRC are temporarily transited to the low level in the on period t1 (which corresponds to high-level portions), may be determined considering power consumption and flicker.

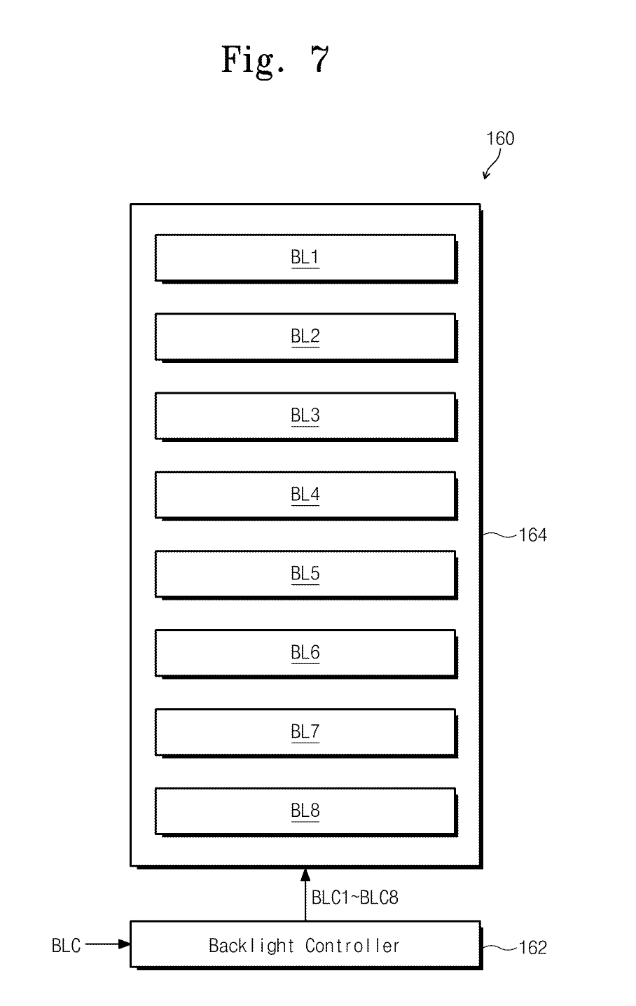

FIG. 7 is a block diagram illustrating the backlight unit 160 illustrated in FIG. 1.

Referring to FIG. 7, the backlight unit 160 includes a backlight controller 162 and a light source part 164. The light source part 164 includes a plurality of light emitting blocks BL1 to BL8. In one or more embodiments, the light source part 164 includes eight light emitting blocks BL1 to BL8. In one or more embodiments, the number of the light emitting blocks in the light source part 164 is other than eight. Each of the first to eight light emitting blocks BL1 to BL8 includes a plurality of red light emitting units (not shown), a plurality of green light emitting units (not shown), and a plurality of blue light emitting units (not shown).

The backlight controller 162 generates first to eighth block control signals BLC1 to BLC8 to turn on or off the first to eighth light emitting blocks BL1 to BL8 in response to the backlight control signal BLC from the timing controller 130 illustrated in FIG. 1. Each of the first to eighth light emitting blocks BL1 to BL8 is turned on or off in response to a corresponding block control signal of the first to eighth block control signals BLC1 to BLC8. For instance, the first light emitting block BL1 is turned on or off in response to the first block control signal BLC1, and the second light emitting block BL2 is turned on or off in response to the second block control signal BLC2.

The first to eighth light emitting blocks BL1 to BL8 may be sequentially turned on or off in response to the first to eighth block control signals BLC1 to BLC8. That is, the second light emitting block BL2 is turned on after (or when) the first light emitting block BL1 has been turned on for a first predetermined length of time. In addition, the third light emitting block BL3 is turned on after (or when) the second light emitting block BL2 has been turned on for the first predetermined length of time or for a second predetermined length of time. Analogously, the fourth to eighth light emitting blocks BL4 to BL8 may be sequentially turned on. Analogously, the first to eighth light emitting blocks BL1 to BL8 may be sequentially turned off.

In one or more embodiments, the gate lines GL1 to GLn are grouped into eight gate line groups, and the first to eighth light emitting blocks BL1 to BL8 respectively correspond to the eighth gate line groups. For example, the first light emitting block BL1 corresponds to a first gate line group. The first light emitting block BL1 is turned on when a first gate line of the first gate line group starts to receive a gate on voltage. Similarly, the second light emitting block BL2 corresponds to a second gate line group. The second light emitting block BL2 is turned on when a first gate line of the second gate line group starts to receive the gate on voltage.

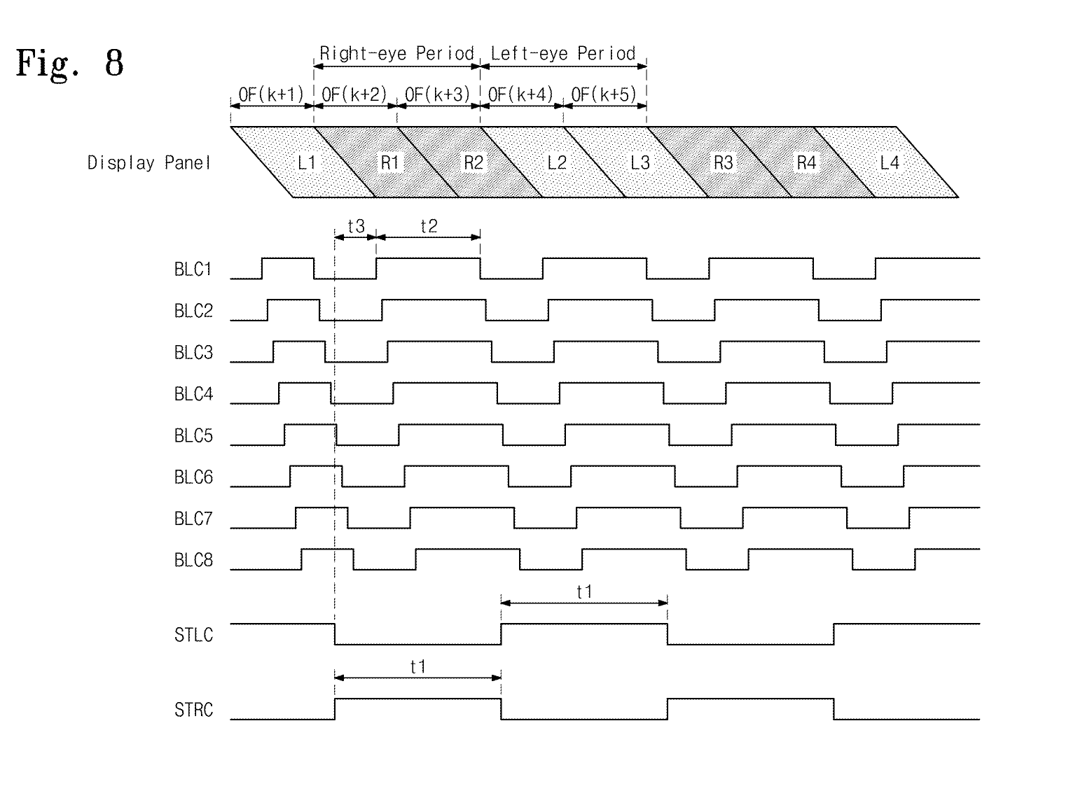

FIG. 8 is a timing diagram illustrating light emitting blocks sequentially turned on and off.

Referring to FIG. 1. FIG. 7, and FIG. 8, the backlight controller 162 sequentially activates the first to eighth block control signals BLC1 to BLC8 in response to the backlight control signal BLC from the timing controller 130. Each of the first to eighth light emitting blocks BL1 to BL8 illustrated in FIG. 7 is turned on when the data voltage corresponding to the second image signal DATA2 is applied to pixels connected to the first gate line included in the corresponding gate line group. The on period t2 during which each of the first to eighth block control signals BLC1 to BLC8 is maintained at the high level is the same as described in FIG. 3.

Although the first to eighth light emitting blocks BL1 to BL8 are sequentially turned on, the on period t2 of each of the first to eighth light emitting blocks BL1 to BL8 is repeated at every two output frames, and thus the brightness of the image displayed in the display panel 110 may be improved in comparison with the brightness provided in a conventional display apparatus.

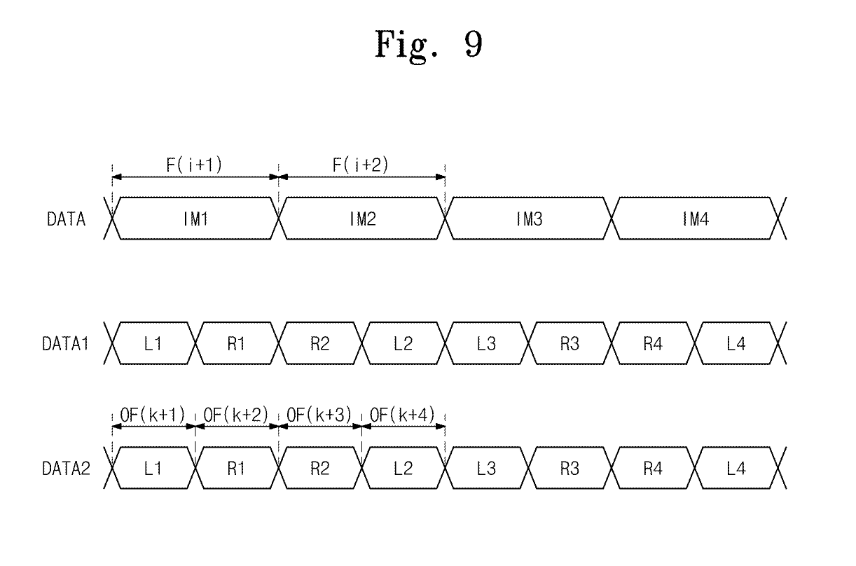

FIG. 9 is a view illustrating the first image signal and the second image signal in accordance with an operation of the scaler and the timing controller illustrated in FIG. 1 according to one or more embodiments of the present invention.

Referring to FIGS. 1 and 9, the scaler 120 receives the image signal DATA from the external source (not shown). Using an image signal associated with one frame in the received image signal DATA, the scaler 120 may generate a left-eye image signal and a right-eye image signal. In one or more embodiments, the scaler 120 separates (and/or converts) the image signal corresponding to one frame in the received image signal DATA into a left-eye image signal and a right-eye image signal. For instance, an image signal IM1 for a first frame F(i+1) is separated (and/or converted) into a first left-eye image signal L1 and a first right-eye image signal R1, and an image signal IM2 for a second frame F(i+2) is separated (and/or converted) into a second left-eye image signal L2 and a second right-eye image signal R2.

The scaler 120 outputs the left-eye image signal and the right-eye image signal for one frame as the first image signal DATA1 for the one frame, but the scaler 120 may change the output order of the left-eye image signal and the right-eye image signal.

For example, the first left-eye image signal L1 and the first right-eye image signal R1 for the first frame F(i+1) are sequentially output as the first image signal DATA1 for the first frame F(i+1). Nevertheless, the second left-eye image signal L2 and the second right-eye image signal R2 for the second frame F(i+2) are output in the order of the second right-eye image signal R2 and then the second left-eye image signal L2 as the first image signal DATA1 for the second frame F(i+2).

That is, the left-eye image signal and the right-eye image signal of the image signal DATA for each of the odd-numbered frames F(i+1) and F(i+3) are output in the order of the left-eye image signal and then the right-eye image signal as the first image signal DATA1 for the corresponding odd-numbered frame. Nevertheless, the left-eye image signal and the right-eye image signal of the image signal DATA for each of the even-numbered frames F(i+2) and F(i+4) are output in the order of the right-eye image signal and then the left-eye image signal as the first image signal DATA1 for the corresponding even-numbered frame, wherein the order is opposite to the order of the left-eye image signal and then the right-eye image signal for the odd-numbered frames such as frames F((i+1) and F(i+3).

The timing controller 130 processes the first image signal DATA1 from the scaler 120 in consideration of the operation condition of the display panel 110 and outputs a second image signal DATA2.

In one or more embodiments, as illustrated in the example of FIG. 2, the output order of the right-eye image signal and then the left-eye image signal is controlled by the timing controller 130 (illustrated in FIG. 1). In one or more embodiments, the output order of the right-eye image signal and then the left-eye image signal is controlled by the scaler 120, as illustrated in the example of FIG. 9.

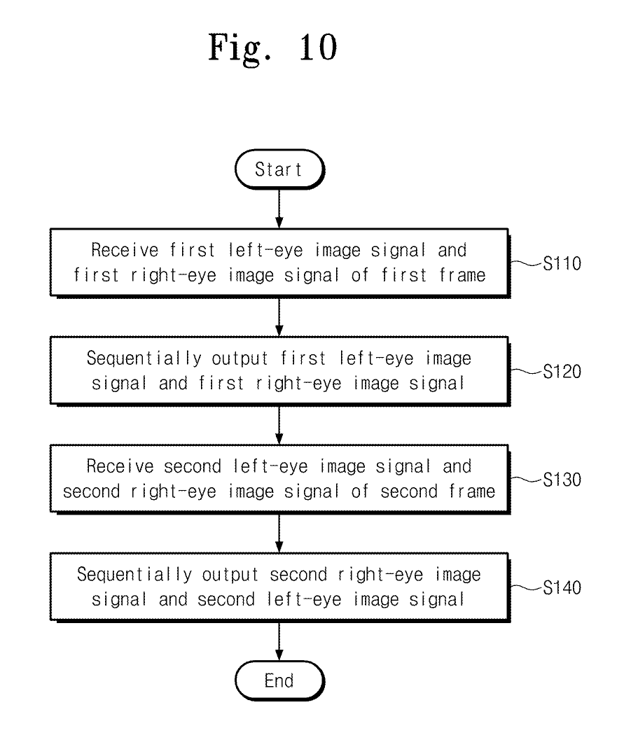

FIG. 10 is a flowchart explaining a method of driving the display apparatus illustrated in FIG. 1. For convenience of explanation, the driving method of the display apparatus will be described with reference to FIGS. 1, 2, 4, and 9.

The scaler 120 receives the image signal DATA from the external source (not shown). The scaler 120 separates (and/or converts) the image signal corresponding to one frame in the received image signal DATA into a left-eye image signal and a right-eye image signal. For instance, the image signal IM1 of the first frame F(i+1) is separated (and/or converted) into the first left-eye image signal L1 and the first right-eye image signal R1, and the image signal IM2 of the second frame F(i+2) is separated (and/or converted) into the second left-eye image signal L2 and the second right-eye image signal R2. The scaler 120 sequentially outputs the left-eye image signal and the right-eye image signal for one frame as the first image signal DATA1.

The timing controller 130 receives the first left-eye image signal L1 and the first right-eye image signal R1 for the first frame F(i+1) from the scaler 120 (in Step S110). The first left-eye image signal L1 and the first right-eye image signal R1 of the first frame F(i+1) are sequentially output (by the timing controller 130) as the second image signal DATA2 for the first frame F(i+1) during the first output frame OF(k+1) and the second output frame OF(k+2), respectively (in Step S120).

The timing controller 130 receives the second left-eye image signal L2 and the second right-eye image signal R2 for the second frame F(i+2) (in Step S130). The second left-eye image signal L2 and the second right-eye image signal R2 for the second frame F(i+2) are consecutively output as the second image signal DATA2 for the second frame F(i+2) during the third output frame OF(k+3) and the fourth output frame OF(k+4) in the order of the second right-eye image signal R2 and then the second left-eye image signal L2 (in Step S140).

The left-eye shutter control signal STLC used to control the left-eye shutter STL of the shutter glasses 170 is set to the high level (i.e., a left-shutter-opening level) during the left-eye periods in which the left-eye image is displayed, e.g., output frames OF(k+1) and OF(k+4), etc., and set to the low level (i.e., a left-shutter-closing level) during the right-eye periods. In addition, the right-eye shutter control signal STRC used to control the right-eye shutter STR of the shutter glasses 170 is set to the high level (i.e., a right-shutter-opening level) during the right-eye periods in which the right-eye image is displayed, e.g., output frames OF(k+2) and OF(k+3), etc., and set to the low level (i.e., a right-shutter-closing level) during the left-eye periods.

In one or more embodiments, since each of the right-eye period and the left-eye period includes two output frames, the backlight unit 160 is turned on and off every two output frames. Accordingly, the on period t2 in which the backlight unit 160 is turned on is lengthened in comparison with the backlight on period according to a conventional driving method of turning on and off the backlight unit 160 every one output frame. Advantageously, brightness in the image displayed in the display panel 110 may be improved in view of image brightness associated with conventional display apparatus.

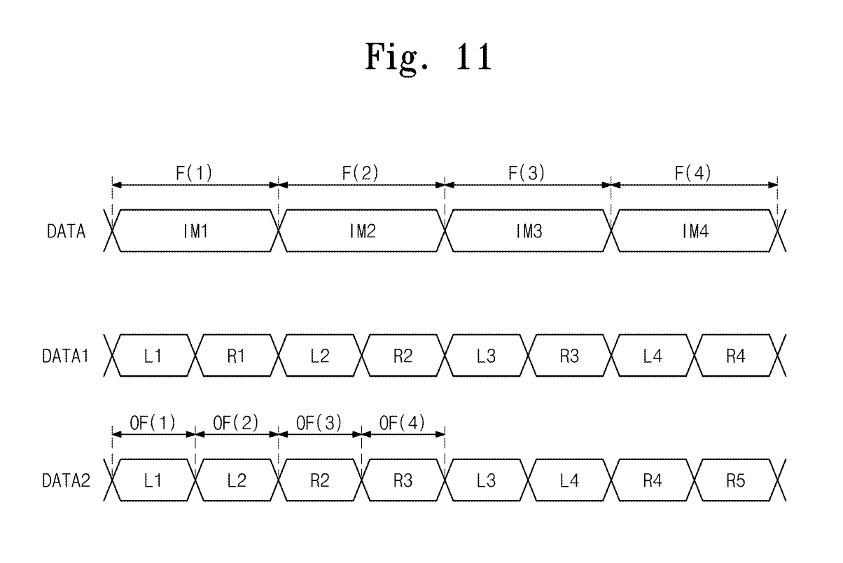

FIG. 11 is a view illustrating a first image signal and a second image signal in accordance with an operation of a timing controller illustrated in FIG. 1 according to one or more embodiments of the present invention.

Referring to FIGS. 1 and 11, the scaler 120 receives the image signal DATA from the external source (not shown). The scaler 120 separates (and/or converts) an image signal corresponding to one frame of the received image signal DATA into a left-eye image signal and a right-eye image signal for the one frame. The scaler 120 outputs the left-eye image signal and the right-eye image signal as the first image signal DATA 1 for the one frame.

The timing controller 130 outputs the first left-eye image signal L1 without outputting the first right-eye image signal R1 for a first frame F(1). Immediately following outputting the first left-eye image signal L1, the timing controller 130 sequentially outputs the second left-eye image signal L2 and the second right-eye image signal R2, which correspond to a second frame F(2) in the first image data DATA1. Immediately following outputting the second right-eye image signal R2, the timing controller 130 sequentially outputs the third right-eye image signal R3 and the third left-eye image signal L3, which correspond to a third frame F(3) in the first image signal DATA1. The first left-eye image signal L1 and the second left-eye image signal L2 are output for the first frame F(1). The second right-eye image signal R2 and the third right-eye image signal R3 are output for the second frame F(2).

That is, the timing controller 130 removes the first right-eye image signal R1 associated with the first frame F(1), sequentially outputs the left-eye image signal and the right-eye image signal associated with each of even-numbered frames, such as F(2) and F(4), according to the order in the first image signal DATA1, and outputs the left-eye image signal and the right-eye image signal associated with each of the odd-numbered frames, such as F(3) and F(5), in the order of the right-eye image signal and then the left-eye image signal, i.e., opposite to the order in the first image signal DATA1.

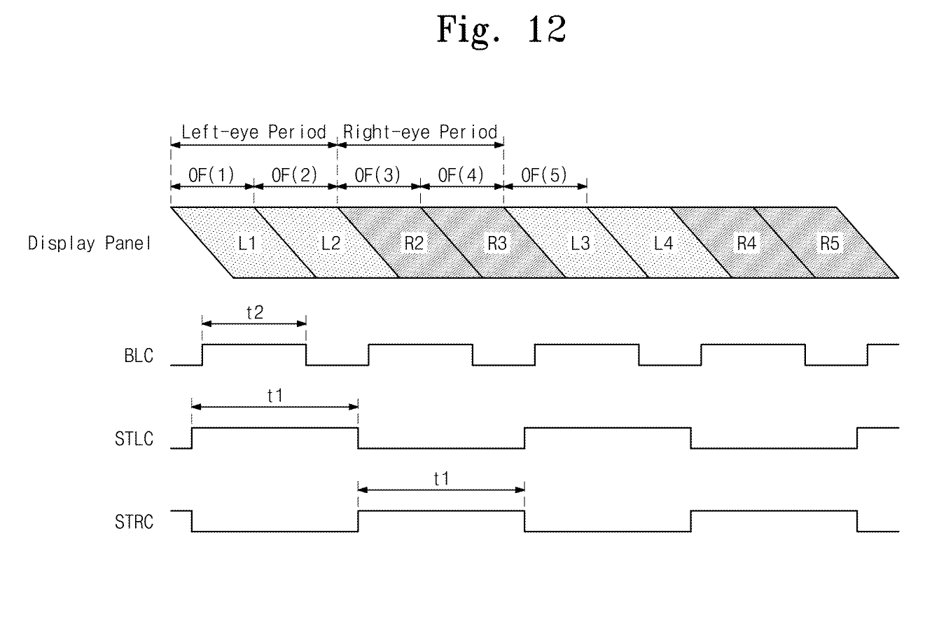

FIG. 12 is a timing diagram illustrating a relation between the image displayed in the display panel using the second image signal illustrated in FIG. 11, the backlight control signal, the left-eye shutter control signal, and the right-eye shutter control signal.

Referring to FIG. 12, in one or more embodiments, when the gate lines G1 to Gn illustrated in FIG. 1 are sequentially provided with gate on signals during the first output frame OF(1), the first left-eye image signal L1 is displayed in the display panel 110. Similarly, the second left-eye image signal L2, the second right-eye image signal R2, the third right-eye image signal R3, and the third left-eye image signal L3 are displayed in the display panel 110 during the second output frame OF(2), the third output frame OF(3), the fourth output frame OF(4), and the fifth output frame OF(5), respectively.

Therefore, right-eye periods each corresponding to two consecutive output frames are alternately repeated with left-eye periods, each corresponding to two consecutive output frames. The first output frame OF(1) and the second output frame OF(2), in which the first left-eye image signal L1 and the second left-eye image signal L2 are respectively displayed, correspond to a left-eye period. The third output frame OF(3) and the fourth output frame OF(4), in which the second right-eye image signal R2 and the third right-eye image signal R3 are respectively displayed, correspond to a right-eye period.

The timing controller 130 illustrated in FIG. 1 outputs the left-eye shutter control signal STLC and the right-eye shutter control signal STRC to open the left-eye shutter STL and close the right-eye shutter STR in the left-eye period during which the left-eye image signal is displayed in the display panel 110. Similarly, the timing controller 130 outputs the left-eye shutter control signal STLC and the right-eye shutter control signal STRC to close the left-eye shutter STL and open the right-eye shutter STR in the right-eye period during which the right-eye image signal is displayed in the display panel 110.

Therefore, the left-eye shutter control signal STLC is set to the high level for (and/or during) the left-eye periods, including a left-eye period corresponding to the output frames OF(1) and OF(2), in which left-eye image signals are output. The left-eye shutter control signal STLC is set to the low level for (and/or during) the right-eye periods. The right-eye shutter control signal STRC is set to the high level for (and/or during) the right-eye periods, including a right-eye period corresponding to the output frames OF(3) and OF(4), in which right-eye image signals are output. The right-eye shutter control signal STRC is set to the low level for (and/or during) the left-eye periods.

The off times toff1 to toff3 described with reference to FIGS. 4 to 6 may be applied to the example described with reference to FIG. 12.

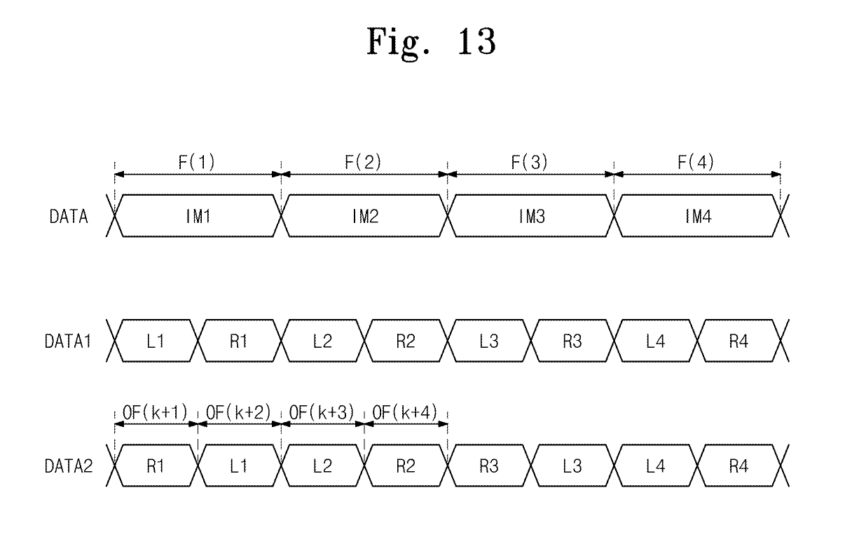

FIG. 13 is a view illustrating a first image signal and a second image signal in accordance with the operation of the timing controller illustrated in FIG. 1 according to one or more embodiments of the present invention.

Referring to FIGS. 1 and 13, the scaler 120 receives the image signal DATA from the external source (not shown). The scaler 120 separates (and/or converts) an image signal corresponding to one frame of the received image signal DATA into a left-eye image signal and a right-eye image signal for the one frame. The scaler 120 outputs the left-eye image signal and the right-eye image signal as the first image signal DATA1 for the one frame.

The timing controller 130 outputs the first left-eye image signal L1 and the first right-eye image signal R1 corresponding to the first frame F(1) in the first image signal DATA 1 in the order of the first right-eye image signal R1 and then the first left-eye image signal L1 as the second image signal DATA2 for the first frame F(1). Immediately following outputting the first left-eye image signal L1, the timing controller 130 sequentially outputs the second left-eye image signal L2 and the second right-eye image signal R2 corresponding to a second frame F(2) as the second image signal DATA2 for the second frame F(2).

That is, the timing controller 130 outputs the left-eye image signal and the right-eye image signal associated with each of the odd-numbered frames, such as F(1) and F(3), in the order of the right-eye image signal and then the left-eye image signal (opposite to the order in the first image signal DATA1), and sequentially outputs the left-eye image signal and the right-eye image signal associated with each of the even-numbered frames, such as F(2) and F(4) according to the order in the first image signal DATA1.

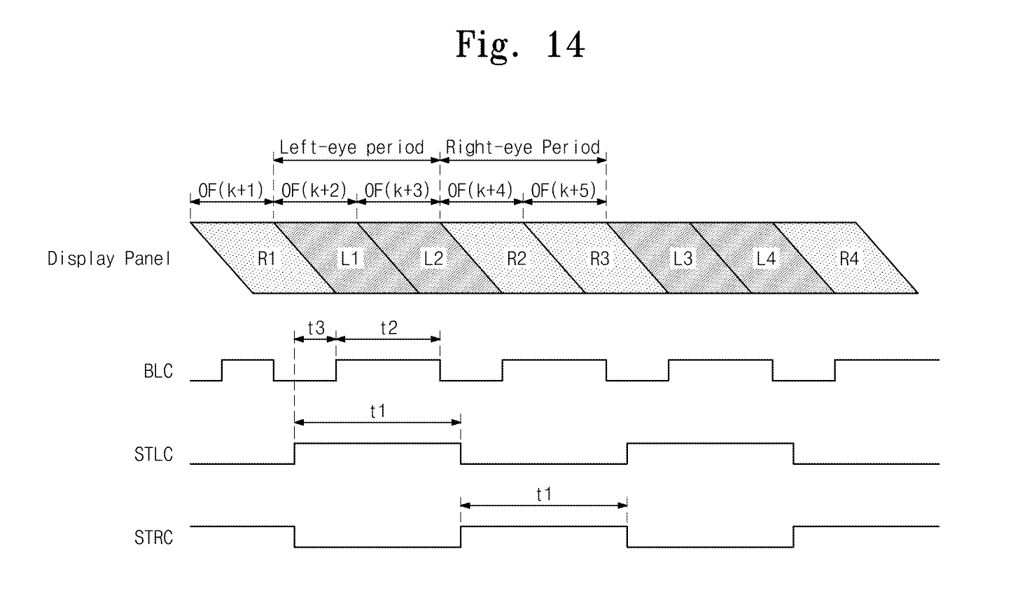

FIG. 14 is a timing diagram illustrating a relation between the image displayed in the display panel using the second image signal illustrated in FIG. 13, the backlight control signal, the left-eye shutter control signal, and the right-eye shutter control signal.

Referring to FIG. 14, in one or more embodiments, when the gate lines G1 to Gn illustrated in FIG. 1 are sequentially provided with gate on signals during the first output frame OF(k+1), the first right-eye image signal R1 is displayed in the display panel 110. Similarly, the first left-eye image signal L1, the second left-eye image signal L2, the second right-eye image signal R2, and the third right-eye image signal R3 are displayed in the display panel 110 during the second output frame OF(k+2), the third output frame OF(k+3), the fourth output frame OF(k+4), and the fifth output frame OF(k+5), respectively.

Therefore, left-eye periods, each corresponding to two consecutive output frames, are alternately repeated with right-eye periods, each corresponding to two consecutive output frames, except for the first output frame OF(k+1). The second output frame OF(k+2) and the third output frame OF(k+3), in which the first left-eye image signal L1 and the second left-eye image signal L2 are respectively displayed, correspond to a left-eye period. The fourth output frame OF(k+4) and the fifth output frame OF(k+5), in which the second right-eye image signal R2 and the third right-eye image signal R3 are respectively displayed, correspond to a right-eye periods.

The timing controller 130 illustrated in FIG. 1 outputs the left-eye shutter control signal STLC and the right-eye shutter control signal STRC to open the left-eye shutter STL and close the right-eye shutter STR in the left-eye period during which the left-eye image signal is displayed in the display panel 110. Similarly, the timing controller 130 outputs the left-eye shutter control signal STLC and the right-eye shutter control signal STRC to close the left-eye shutter STL and open the right-eye shutter STR in the right-eye period during which the right-eye image signal is displayed in the display panel 110.

Thus, the right-eye shutter control signal STRC is set to the high level for (and/or during) the first output frame OF(k+1) and the right-eye periods, including OF(k+4) and OF(k+5), in which right-eye image signals are output. The right-eye shutter control signal STRC is set to the low level for (and/or during) the left-eye periods. The left-eye shutter control signal STLC is set to the high level for (and/or during) the left-eye periods, including a left-eye period corresponding to the output frames OF(k+2) and OF(k+3), in which left-eye image signals are output. The left-eye shutter control signal STLC is set to the low level for (and/or during) the right-eye periods.

The off times toff1 to toff3 described with reference to FIGS. 4 to 6 may be applied to the example described with reference to FIG. 14.

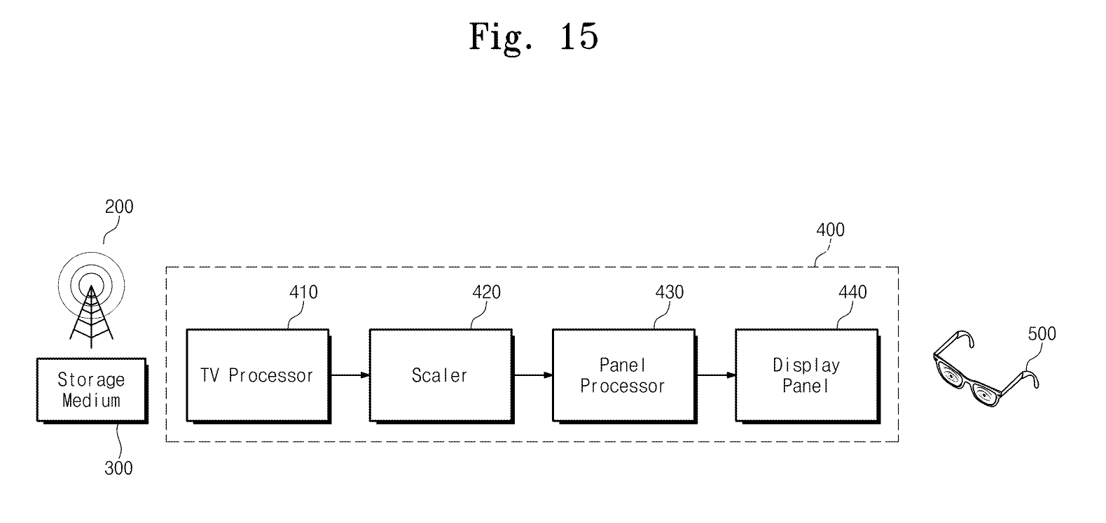

FIG. 15 is a view illustrating a 3D television system according to one or more embodiments of the present invention.

Referring to FIG. 15, the 3D TV system 400 receives the image signal DATA from a broadcasting station 200 or a storage medium 300. The broadcasting station 200 may be a terrestrial broadcasting station or a cable broadcasting station, and a broadcast signal from the broadcasting station 200 may be applied to the 3D TV system 400 through one or more of various paths, e.g., one or more of a cable, a satellite, a terrestrial antenna, etc. The storage medium 300 may be, for example, but not limited to, a high-definition optical disc, e.g., one of a DVD, a blue-ray disc, etc. The display apparatus illustrated in FIG. 1 may be implemented using one or more various devices, such as a monitor, a notebook computer, a mobile device, etc., in addition to or alternative to one or more components in the 3D TV system 400 illustrated in FIG. 15.

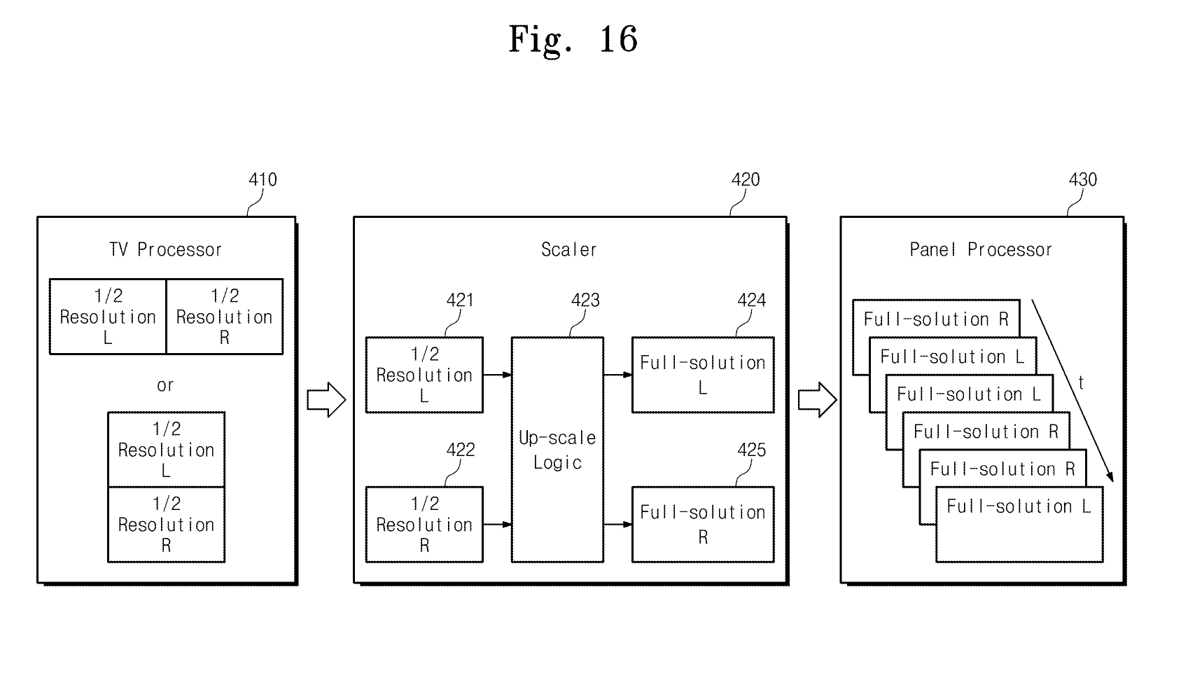

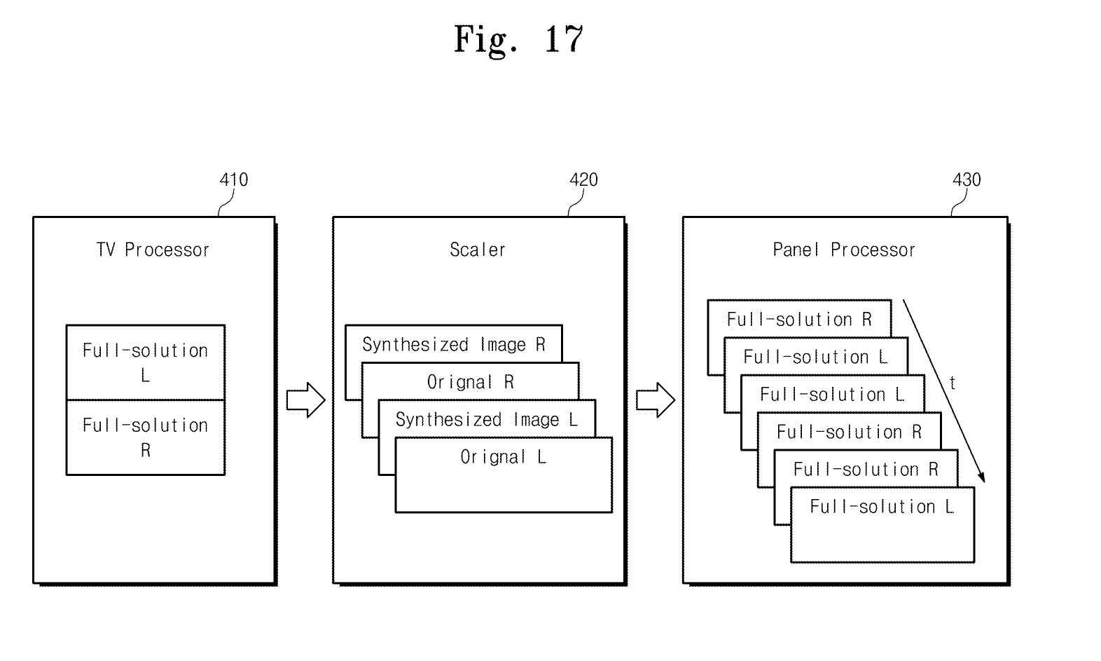

The 3D TV system 400 includes a TV processor 410, a scaler 420, a panel processor 430, and a display panel 440. The operation of the 3D TV system 400 will be described with reference to FIGS. 16 and 17.

FIG. 16 is a view explaining a process of displaying a broadcast signal received from the broadcasting station using the display panel of the 3D television system illustrated in FIG. 15.

Referring to FIGS. 15 and 16, the TV processor 410 separates the broadcast signal received from the broadcasting station 200 (through the antenna or the cable) into the image signal DATA and a sound signal and applies the image signal DATA to the scaler 420. The broadcast signal with a frequency of about 60 Hz from the broadcasting station 200 may have a side-by-side format or a top-down format. According to the side-by-side format, one frame is divided in a vertical direction, and a left-eye image and a right-eye image are respectively provided (and/or displayed) in a left portion and a right portion of the one frame. According to the top-down format, one frame is divided in a horizontal direction, and a left-eye image and a right-eye image are respectively provided (and/or displayed) in an upper portion and a lower portion of the one frame. The image signal DATA output from the TV processor 410 includes the left-eye image signal L and the right-eye image signal R of the one frame.

The scaler 420 includes input memories 421 and 422, an up-scale logic 423, and output memories 424 and 425. The input memory 421 stores the left-eye image signal L of the image signal DATA and the input memory 422 stores the right-eye image signal R of the image signal DATA. In one or more embodiments, the left-eye image signal L and the right-eye image signal R are respectively stored in the input memories 421 and 422 have a resolution corresponding to a half (½) of a resolution of the display panel 440. For instance, in the case that the display panel 440 has the resolution of 3840×2160, e.g., ultra high definition, each of the image signals L and R, which is stored in one of the input memories 421 and 423, has the resolution of 1920×2160.

The up-scale logic 423 converts the image signals having the half-resolution and provided from the input memories 421 and 422 to full-resolution signals appropriate to the display panel 440 and stores the full-resolution signals into the output memories 424 and 425. The scaler 420 sequentially outputs the full-resolution left-eye image signal L and the full-resolution right-eye image signal R from the output memories 424 and 425.

The panel processor 430 includes the timing controller 130, the data driver 140, and the gate driver 150. The panel processor 430 provides the left-eye image signals L and the right-eye image signals R, received from the scaler 420 and having full-resolution, in a predetermined output order. The output order of the left-eye image signals L and the right-eye image signals R may include one or more of the orders discussed in the examples of FIGS. 3 to 14.

FIG. 17 is a view explaining a process of displaying an image signal received from the blue-ray disc using the display panel of the 3D television system illustrated in FIG. 15.

Referring to FIGS. 15 and 17, the image signal at a frequency of about 24 Hz received from the blue-ray disc 300 includes a left-eye image signal and a right-eye image signal, each having full-resolution. Therefore, the image signal DATA output from the TV processor 410 includes the full-resolution left-eye image signal and the full-resolution right-eye image signal.

The scaler 420 converts the broadcast signal of about 24 Hz from the TV processor 410 to an image signal of about 48 Hz and sequentially outputs the image signals for each frame. The panel processor 430 provides left-eye image signals and right-eye image signals, each having the full-resolution, to the display panel 440 in a predetermined output order. In one or more embodiments, the output order of the left-eye image signals and the right-eye image signals may include one or more of the orders discussed in the examples of FIGS. 3 to 14.

As illustrated in FIGS. 15 to 17, in one or more embodiments, the scaler 420 may be implemented in an integrated circuit that is separate from the TV processor 410 and the panel processor. In one or more embodiments, the scaler 420 may be implemented in the TV processor 410 or the panel processor 430. In one or more embodiments, the scaler 420 may be called as a 3D converter since the scaler 420 separates an image signal for one frame into a left-eye image signal and a right-eye image signal for the display system to display the 3D image.

Although the embodiments of the present invention have been described, it is understood that the present invention should not be limited to these embodiments. Various changes and modifications can be made by one ordinary skilled in the art within the spirit and scope of the present invention.

What is claimed is:

1. A display apparatus comprising:
a controller configured to receive image data associated with at least a first frame and a second frame immediately following the first frame, the controller being further configured to generate image signals using the image data;
a data driver configured to generate one or more data signals using the image signals; and
a display panel configured to display one or more images using the one or more data signals,
wherein the image signals include two consecutive first-eye image signals and two consecutive second-eye image signals immediately following or immediately preceding the two consecutive first-eye image signals.

2. The display apparatus of claim 1,
wherein the two consecutive first-eye image signals are two left-eye image signals, and
wherein the two consecutive second-eye image signals are two right-eye image signals.

3. The display apparatus of claim 1,
wherein the two consecutive first-eye image signals are two right-eye image signals, and
wherein the two consecutive second-eye image signals are two left-eye image signals.

4. The display apparatus of claim 1,
wherein the image signals include a first first-eye image signal, a first second-eye image signal immediately following the first first-eye image signal, a second second-eye image signal immediately following the first second-eye image signal, and a second first-eye image signal immediately following the second second-eye image signal,
wherein the first first-eye image signal and the first second-eye image signal are associated with the first frame,
wherein the second second-eye image signal and the second first-eye image signal are associated with the second frame,
wherein the two consecutive second-eye image signals are the first second-eye image signal and the second second-eye image signal, and
wherein the two consecutive first-eye image signals include the second first-eye image signal.

5. The display apparatus of claim 4, further comprising a scaler configured to generate the image data using processed data, wherein the image data includes the first first-eye image signal, the first second-eye image signal immediately following the first first-eye image signal, the second first-eye image signal immediately following the first second-eye image signal, and the second second-eye image signal immediately following the second first-eye image signal.

6. The display apparatus of claim 4, further comprising a scaler configured to generate the image data using processed data, wherein the image data includes the first first-eye image signal, the first second-eye image signal immediately following the first first-eye image signal, the second second-eye image signal immediately following the first second-eye image signal, and the second first-eye image signal immediately following the second second-eye image signal.

7. The display apparatus of claim 4, further comprising a scaler configured to generate the image data using processed data, wherein the image data includes the first second-eye image signal, the first first-eye image signal immediately following the first second-eye image signal, the second second-eye image signal immediately following the first first-eye image signal, and the second first-eye image signal immediately following the second second-eye image signal.

8. The display apparatus of claim 1,
wherein the image data includes a first first-eye image signal, a first second-eye image signal, a second first-eye image signal, a second first-eye image signal, a third first-eye image signal, a third second-eye image signal,
wherein the image signals include the first first-eye image signal, the second first-eye image signal immediately following the first first-eye image signal, the second second-eye image signal immediately following the second first-eye image signal, and the third second-eye image signal immediately following the second second-eye image signal,
wherein the first first-eye image signal and the second first-eye image signal are associated with the first frame,
wherein the second second-eye image signal and the third second-eye image signal are associated with the second frame,
wherein the two consecutive first-eye image signals are the first first-eye image signal and the second first-eye image signal, and
wherein the two consecutive second-eye image signals are the second second-eye image signal and the third second-eye image signal.

9. The display apparatus of claim 1,
wherein the two consecutive first-eye image signals include a preceding signal corresponding to a first output frame and a succeeding signal corresponding to a second output frame,
wherein the display apparatus further comprises:
a first-eye shutter configured to open when the display panel displays a first image corresponding to the preceding signal and when the display panel displays a second image corresponding to the succeeding signal; and
a backlight unit configured to change from a light-off state to a light-on state after the first-eye shutter has changed from a shutter-closed state to a shutter-open state for a predetermined period.

10. The display apparatus of claim 9, wherein the backlight unit is configured to change from the light-off state to the light-on state during the first output frame.

11. The display apparatus of claim 9, wherein the backlight unit is turned off during the second output frame.

12. The display apparatus of claim 9, wherein the backlight unit is configured to be off at a transition from the first output frame to the second output frame.

13. A method for displaying one or more images, the method comprising:
receiving image data that is associated with at least a first frame and a second frame immediately following the first frame;
using the image data and using a controller that includes hardware circuitry, to generate image signals;
using the image signals and using a display panel to display the one or more images,
wherein the image signals include two consecutive first-eye image signals and two consecutive second-eye image signals immediately following or immediately preceding the two consecutive first-eye image signals.

14. The method of claim 13,
wherein the two consecutive first-eye image signals are two left-eye image signals, and
wherein the two consecutive second-eye image signals are two right-eye image signals.

15. The method of claim 13,
wherein the two consecutive first-eye image signals are two right-eye image signals, and
wherein the two consecutive second-eye image signals are two left-eye image signals.

16. The method of claim 13,
wherein the image signals include a first first-eye image signal, a first second-eye image signal immediately following the first first-eye image signal, a second second-eye image signal immediately following the first second-eye image signal, and a second first-eye image signal immediately following the second second-eye image signal,
wherein the first first-eye image signal and the first second-eye image signal are associated with the first frame,
wherein the second second-eye image signal and the second first-eye image signal are associated with the second frame,
wherein the two consecutive second-eye image signals are the first second-eye image signal and the second second-eye image signal, and
wherein the two consecutive first-eye image signals include the second first-eye image signal.

17. The method of claim 16, further comprising: generating the image data using processed data,
wherein the image data includes the first first-eye image signal, the first second-eye image signal immediately following the first first-eye image signal, the second first-eye image signal immediately following the first second-eye image signal, and the second second-eye image signal immediately following the second first-eye image signal.

18. The method of claim 16, further comprising: generating the image data using processed data,
wherein the image data includes the first first-eye image signal, the first second-eye image signal immediately following the first first-eye image signal, the second second-eye image signal immediately following the first second-eye image signal, and the second first-eye image signal immediately following the second second-eye image signal.

19. The method of claim 16, further comprising: generating the image data using processed data,
wherein the image data includes the first second-eye image signal, the first first-eye image signal immediately following the first second-eye image signal, the second second-eye image signal immediately following the first first-eye image signal, and the second first-eye image signal immediately following the second second-eye image signal.

20. The method of claim 13,
wherein the image data includes a first first-eye image signal, a first second-eye image signal, a second first-eye image signal, a second first-eye image signal, a third first-eye image signal, a third second-eye image signal,
wherein the image signals include the first first-eye image signal, the second first-eye image signal immediately following the first first-eye image signal, the second second-eye image signal immediately following the second first-eye image signal, and the third second-eye image signal immediately following the second second-eye image signal,
wherein the first first-eye image signal and the second first-eye image signal are associated with the first frame,
wherein the second second-eye image signal and the third second-eye image signal are associated with the second frame,
wherein the two consecutive first-eye image signals are the first first-eye image signal and the second first-eye image signal, and
wherein the two consecutive second-eye image signals are the second second-eye image signal and the third second-eye image signal.

21. The method of claim 13,
wherein the two consecutive first-eye image signals include a preceding signal corresponding to a first output frame and a succeeding signal corresponding to a second output frame,
wherein the method further comprises:
keeping a first-eye shutter open when the display panel displays a first image corresponding to the preceding signal and when the display panel displays a second image corresponding to the succeeding signal; and
changing a backlight unit from a light-off state to a light-on state after the first-eye shutter has been changed from a shutter-closed state to a shutter-open state for a predetermined period.

22. The method of claim 21, wherein the backlight unit is configured to change from the light-off state to the light-on state during the first output frame.

23. The method of claim 21, further comprising turning off the backlight unit during the second output frame.

24. The method of claim 21, wherein the backlight unit is off at a transition from the first output frame to the second output frame.
